(19) United States
(12) Patent Application Publication
(10) Pub. No.: US 2022/0029290 A1
(43) Pub. Date: Jan. 27, 2022

(54) SMALL CELL WIRELESS COMMUNICATION DEVICES HAVING ENHANCED BEAMSTEERING CAPABILITY AND METHODS OF OPERATING SAME

(71) Applicant: CommScope Technologies LLC, Hickory, NC (US)

(72) Inventors: Michael BROBSTON, Allen, TX (US); Sammit Patel, Dallas, TX (US)

(21) Appl. No.: 17/413,980

(22) PCT Filed: Dec. 4, 2019
(86) PCT No.: PCT/US2019/064403

§ 371 Date: Jun. 15, 2021

Related U.S. Application Data
(60) Provisional application No. 62/781,192, filed on Dec. 18, 2018.

(51) Int. Cl. H01Q 3/36; H04B 1/38; H01Q 1/24

(52) U.S. Cl. CPC H01Q 3/36; H01Q 1/246; H04B 1/38

(57) ABSTRACT

A small cell wireless communication device includes an antenna having an array of radiating elements, a control circuit, and a transceiver/radio. The transceiver is electrically coupled to the antenna by an array of phase shifters, which are responsive to control signals that encode phase weight information and enable the array of phase shifters and the array of radiating elements to collectively perform elevation beamsteering of wireless signals generated by the transceiver, in response to signals generated by the control circuit upon movement of the antenna. In some instances, these signals generated by the control circuit may include an elevation beam index, which may operate as a pointer into a look-up table, which stores phase-weights to be provided to the array of phase shifters.

### REFERENCE TO PRIORITY APPLICATION

This application claims priority to U.S. Provisional Application Ser. No. 62/781,192, filed Dec. 18, 2018, the disclosure of which is hereby incorporated herein by reference.

### CROSS-REFERENCE TO RELATED APPLICATION

This application is related to commonly assigned International Patent Application No. PCT/US2018/060896, filed Nov. 14, 2018, entitled “Small Cell Base Stations With Strand-Mounted Antennas”, the disclosure of which is hereby incorporated herein by reference.

### FIELD OF THE INVENTION

The present invention relates to cellular communications systems and, more particularly, to small cell cellular communication systems, such as small cell base stations, and methods of operating same.

### BACKGROUND

In a typical cellular communications system, a geographic area is divided into a series of regions that are typically referred to as “cells,” with each cell being served by a corresponding cellular base station. Typically, a cell may serve users who are within a distance of, for example, 1-20 kilometers from the base station, although smaller cells are typically used in urban areas to increase capacity. A base station may include baseband equipment, radios and antennas that are collectively configured to provide two-way radio frequency (“RF”) communications with fixed and mobile subscribers (“users”) that are located throughout the cell. The antennas are often mounted on a tower or other raised structure, with a corresponding RF antenna beam directed outwardly to cover the cell or portion thereof. Typically, a base station antenna includes one or more phase-controlled arrays of radiating elements, with the radiating elements arranged in one or more vertical columns. Herein, the term “vertical” refers to a direction that is perpendicular relative to a plane defined by the horizon.

In order to increase capacity, cellular operators have frequently deployed so-called “small cell” cellular base stations. A small cell base station typically refers to a lower power base station that may operate in a licensed or unlicensed spectrum that has a much smaller range than a typical “macrocell” base station. Thus, a small cell based station may be designed to serve users who are within short distances from the small cell base station (e.g., tens or hundreds of meters). Small cells may also be used to provide cellular coverage in high traffic areas within a macrocell, which allows the macrocell base station to offload much or all of the cellular traffic in the vicinity of the small cell to the small cell base station. Small cells may be particularly effective in Long Term Evolution (“LTE”) cellular networks by efficiently using the available frequency spectrum to maximize network capacity at a reasonable cost.

As will be understood by those skilled in the art, the deployment of small cell base station radios or wireless access networks with sufficient density to provide a high degree of universal coverage within a coverage area typically requires the availability of platforms on which these access node radios can be mounted. These mounting platforms include dedicated poles, buildings, light poles, utility poles, and cable strands, for example.

In particular, and as shown by FIG. 1A, cable strand mounting of small cell base station radios 100 can greatly expand the availability of mounting locations in areas where cable strands 12 can be reliably suspended without environmental interference (e.g., between utility poles). In addition, small cell azimuth beamsteering may be provided under the control of a radio scheduler, to thereby implement spatial multiplexing to multiple nearby users 10a-10d or clusters of users and achieve high spectral efficiency. As shown by the functional block diagram of FIG. 1B, a conventional small cell base station radio 100 may include a two-dimensional antenna array 110. And, the RF carrier signals provided to each radiating element in the array 110 (or small group of elements) may be controlled in electrical phase to thereby implement azimuth beamsteering (i.e., horizontal control of the pointing angle of the main lobe). Using conventional techniques, the transmitted signals (Tx) may be encoded and modulated by the MAC (medium access control) and PHY (physical layer) blocks associated with the baseband unit 112 of the radio 100. The RF channels within the remote radio unit 114 upconvert the transmitted signals to the RF frequency and amplify them to appropriate power levels. The RF signal power is then split into multiple paths, with each path then routed through a corresponding RF phase shifter and then finally to an antenna array element (or group of elements). Advantageously, the scheduler function within the baseband unit 112 determines the azimuth angle of each user and, during the time slot used to communicate to a specific user, sends an azimuth beam index (ABI) as a pointer (e.g., address) to be decoded by the phase weighting block (e.g., nonvolatile memory). In response, the appropriate phase weights for a corresponding ABI can be selected and read from the phase weighting block and provided to the RF phase shifters to thereby steer the antenna beam in the desired azimuth direction of that user.

Conversely, when the radio 100 is operating as a receiver, the RF signals received by each antenna element (or group of elements) can be combined and fed into an RF receiver channel where they are then amplified and downconverted. The PHY and MAC blocks demodulate and decode the received signals (Rx) using conventional techniques.

It is contemplated that 5G and other mobile networks will typically operate using beamforming and massive MIMO techniques in which relatively narrow antenna patterns may be formed by small cell base station radios 100 in order to increase uplink and downlink range and suppress interference. To achieve such goals, these techniques may utilize highly directed antenna main lobes, which are directed toward an individual user or cluster of users. These highly directed antenna main lobes can be expected to have relatively narrow beamwidths of about 20°, and even 10° or less in some applications.

Many small cell radio mounting structures, including the cable strand mounting structures of FIG. 1A, can be expected to provide adequate stability relative to the beamwidths of these 5G access network radios. For example, if an angular platform movement due to wind or other external stimulus is less than 2° while the beamwidth of the main lobe of the small cell is about 10°, then it can be expected that this limited platform movement will not have significant impact on link performance. However, if the angular platform movement approaches the 3 dB elevation beamwidth of the radio access point equipment, then the variation in main lobe pointing due to stimulus such as wind gusts may cause a reduction in the signal strength and result in link degradation.

For the case of cable strand mount installation as shown by FIG. 1A, testing and data has shown that the angular rotation of a small cell antenna may exceed the 3 dB elevation beamwidth of the radio access node under certain conditions. For example, in a windy situation, a small cell base station radio mounted on a cable strand can sway excessively beyond the limits of the main lobe beamwidth and thereby cause a degradation of the link margin. FIG. 1C illustrates a side profile view of the main lobe coverage of a strand mounted small cell radio 100, which correctly illuminates a desired terrestrial coverage area. In this illustration, the radio 100 is unaffected by wind. In contrast, FIGS. 1D-1E illustrate how the coverage of the small cell radio 100 can be impacted by strand sway or torsion due to wind in opposing right-to-left and left-to-right directions. As illustrated by FIGS. 1D-1E, excessive platform sway during windy conditions can cause the illumination of a desired coverage area to be degraded.

### SUMMARY OF THE INVENTION

A small cell wireless communication device according to embodiments of the invention includes an antenna having an array of radiating elements therein, and a transceiver (e.g., radio) electrically coupled to the antenna by an array of phase shifters. This array of phase shifters is responsive to control signals that encode phase weight information and enable the array of phase shifters and the array of radiating elements to collectively perform elevation beamsteering of wireless signals generated by the transceiver. According to some of these embodiments of the invention, a phase weight generator is provided, which is configured to generate the control signals in response to an elevation beam index. A control circuit is also provided, which is configured to generate and adjust the elevation beam index in response to rotational movement of the antenna about an axis. According to additional embodiments of the invention, the control signals provided to the array of phase shifters may encode phase weight information that enables the array of phase shifters and the array of radiating elements to collectively perform elevation and azimuth beamsteering of the wireless signals generated by the transceiver. And, in these embodiments, the phase weight generator may be configured to generate the control signals in response to an azimuth beam index and an elevation beam index. In addition, the phase weight generator can include non-volatile memory therein, which may be arranged as a plurality of phase weight look-up tables. In some embodiments of the invention, each value of the elevation beam index may operate as a pointer to a respective one of the plurality of phase weight look-up tables, and each value of the azimuth beam index may operate as a pointer into a corresponding memory location within the plurality of phase weight look-up tables.

According to further embodiments of the invention, a small cell wireless communication device may include an antenna having an array of radiating elements therein, a control circuit, and a transceiver, which is electrically coupled to the antenna by an array of phase shifters. These phase shifters may be responsive to control signals that encode phase weight information and enable the array of phase shifters and the array of radiating elements to collectively perform elevation beamsteering of wireless signals generated by the transceiver, in response to signals generated by the control circuit upon movement of the antenna. In some of these embodiments, a phase weight generator may be provided, which is configured to generate the control signals in response to an elevation beam index, which can be generated by the control circuit, and an azimuth beam index, which can be generated by a radio scheduler configured to implement spatial multiplexing to multiple users or clusters of users. In some of these embodiments of the invention, the phase weight generator may include a memory device arranged as a plurality of phase weight look-up tables, with each potential value of the elevation beam index operating as a pointer to a respective one of the plurality of phase weight look-up tables, and each value of the azimuth beam index operating as a pointer into a corresponding memory location within the plurality of phase weight look-up tables.

According to additional embodiments of the invention, a wireless communication device may include a strand-mounted small cell base station radio, which is configured to support azimuth and elevation beamsteering. These beamsteering operations may occur by adjusting phase weights provided to an array of phase shifters coupled to a small cell antenna having an array of radiating elements therein. And, this adjustment of phase weights may occur in response to signals generated by: (i) a scheduler that supports spatial multiplexing; and (ii) a control circuit that monitors a vertical disposition of the small cell antenna. This control circuit may include a sensor, which is mounted to the small cell antenna. This sensor may be selected from a group consisting of accelerometers, tilt sensors, inclinometers, gyroscopes, position sensors and orientation sensors. A look-up table may also be provided to generate and adjust the phase weights in real time during beamsteering, in response to an azimuth beam index generated by the scheduler and an elevation beam index generated by the control circuit.

### BRIEF DESCRIPTION OF THE DRAWINGS

The accompanying drawings, which are incorporated in and constitute a part of this specification, illustrate embodiments of the invention, where like reference numbers in the drawing figures refer to the same feature or element and may not be described in detail for every drawing figure in which they appear and, together with a general description of the invention given above, and the detailed description of the embodiments given below, serve to explain the principles of the invention.

FIG. 1A is a perspective view of a strand-mounted small cell base station radio system that utilizes azimuth beamsteering to support spatial multiplexing to multiple users or clusters of users, according to the prior art.

FIG. 1B is a block diagram of the small cell base station radio system of FIG. 1A, according to the prior art.

FIG. 1C is a side perspective view of a desired illumination pattern of the strand-mounted small cell base station radio system of FIG. 1A, when the system is disposed in a vertical plane.

FIG. 1D is a side perspective view of an offset illumination pattern of the strand-mounted small cell base station radio system of FIG. 1A, when the system is offset by an angle of minus ⊖ relative to the vertical plane of FIG. 1C.

FIG. 1E is a side perspective view of an offset illumination pattern of the strand-mounted small cell base station radio system of FIG. 1A, when the system is offset by an angle of plus ⊖ relative to the vertical plane of FIG. 1C.

FIG. 2A is a block diagram of a small cell base station radio system according to an embodiment of the present invention.

FIG. 2B is a side perspective view of a compensated illumination pattern of the strand-mounted small cell base station radio system of FIG. 2A, when the system is offset by an angle of minus ⊖ relative to a vertical plane.

FIG. 2C is a side perspective view of a compensated illumination pattern of the strand-mounted small cell base station radio system of FIG. 2A, when the system is offset by an angle of plus ⊖ relative to a vertical plane.

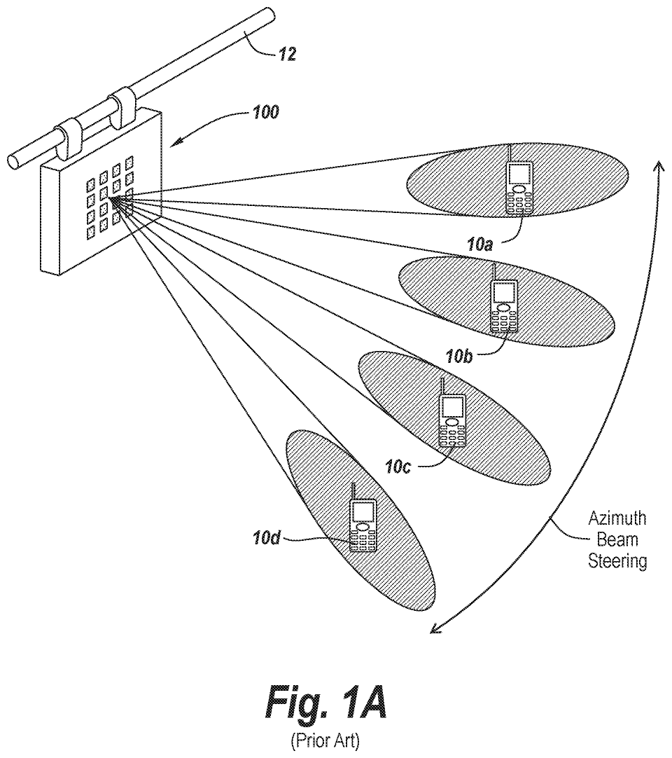

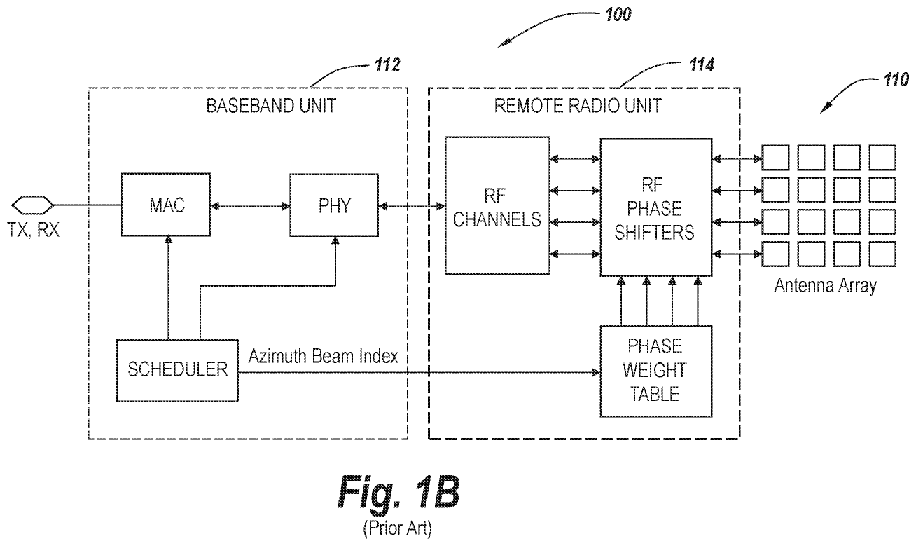

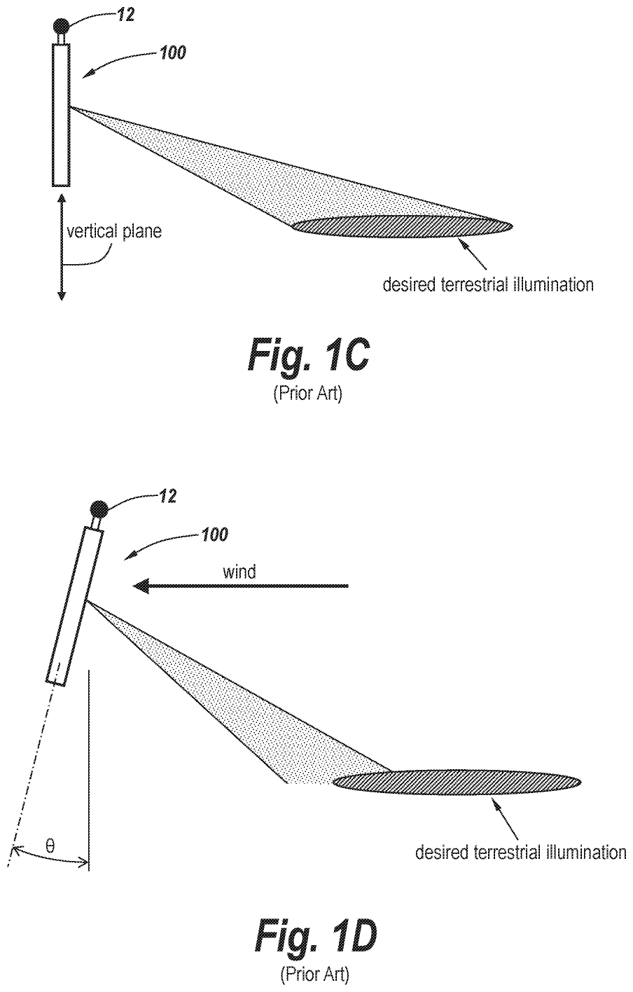

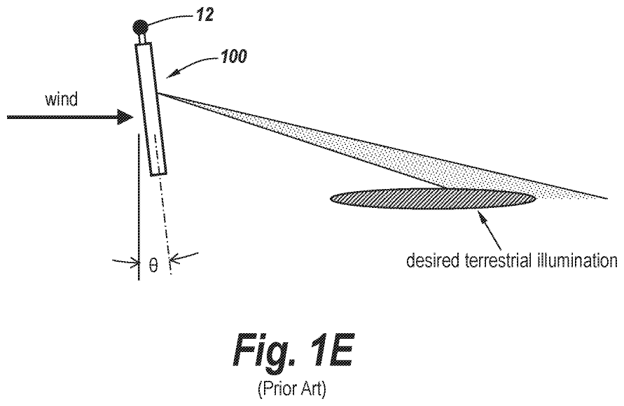

### DETAILED DESCRIPTION OF EMBODIMENTS

The present invention now will be described more fully with reference to the accompanying drawings, in which preferred embodiments of the invention are shown. This invention may, however, be embodied in many different forms and should not be construed as being limited to the embodiments set forth herein; rather, these embodiments are provided so that this disclosure will be thorough and complete, and will fully convey the scope of the invention to those skilled in the art. Like reference numerals refer to like elements throughout.

It will be understood that, although the terms first, second, third, etc. may be used herein to describe various elements, components and/or regions, these elements, components and/or regions should not be limited by these terms. These terms are only used to distinguish one element, component and/or region from another element, component and/or region. Thus, a first element, component and/or region discussed below could be termed a second element, component and/or region without departing from the teachings of the present invention.

The terminology used herein is for the purpose of describing particular embodiments only and is not intended to be limiting of the present invention. As used herein, the singular forms “a,” “an” and “the” are intended to include the plural forms as well, unless the context clearly indicates otherwise. It will be further understood that the terms “comprising”, “including”, “having” and variants thereof, when used in this specification, specify the presence of stated features, steps, operations, elements, and/or components, but do not preclude the presence or addition of one or more other features, steps, operations, elements, components, and/or groups thereof. In contrast, the term “consisting of” when used in this specification, specifies the stated features, steps, operations, elements, and/or components, and precludes additional features, steps, operations, elements and/or components.

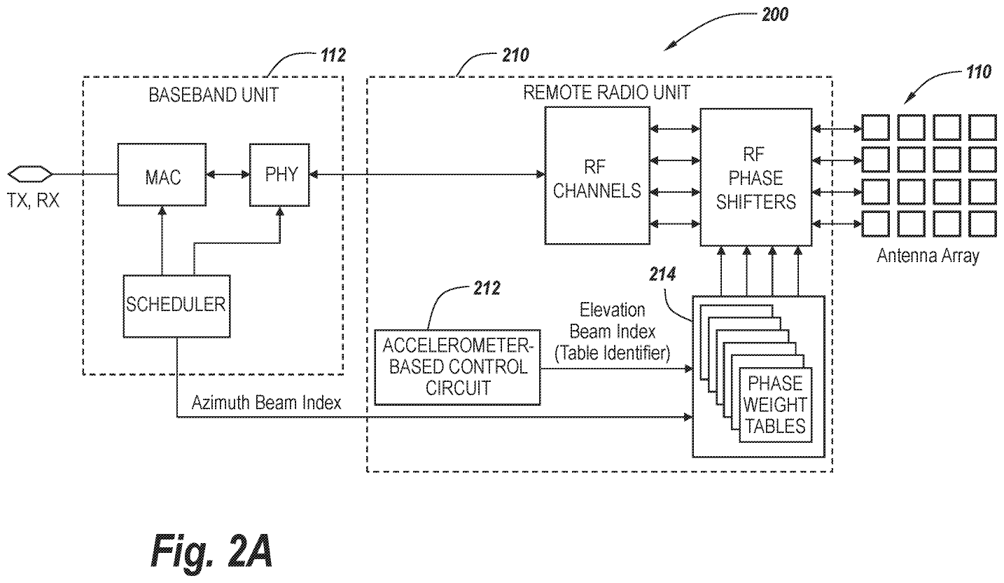

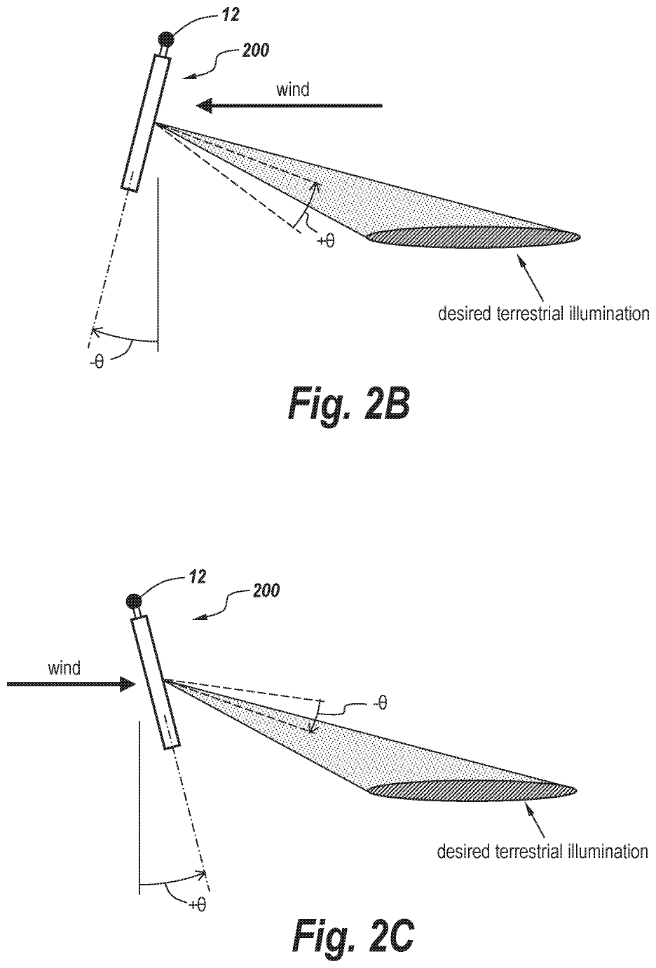

Referring now to FIG. 2A, a wireless communication device according to an embodiment of the invention is illustrated as including a typically strand-mounted small cell base station radio 200. This radio 200 is configured to support both azimuth beamsteering and elevation beamsterring using a baseband unit 112, which contains a scheduler, and a remote radio unit 210, which preferably contains an accelerometer-based control circuit 212 and a phase-weight look-up table 214. As described more fully hereinbelow, these beamsteering operations are performed by adjusting the phase weights provided to an array of RF phase shifters, which are electrically coupled to a small cell antenna 110 having an array of radiating elements therein. These phase weights are adjusted in response to signals generated by the scheduler, which supports spatial multiplexing, and an accelerometer-based control circuit 212, which monitors and automatically compensates for changes in a vertical disposition of the small cell antenna 110 (e.g., using a built-in accelerometer). These signals may be configured as an azimuth beam index (ABI) generated by the scheduler within the baseband unit 112 and an elevation beam index (EBI) generated by the accelerometer-based control circuit 212, in order to support phase-weight generation using computationally efficient look-up operations. In alternative embodiments of the invention, the function of the accelerometer sensor within the accelerometer-based control circuit 212 may be performed by a tilt sensor, inclinometer, gyroscope, position sensor and orientation sensor, for example.

In particular, the built-in accelerometer operates to detect any tilt/rotation (relative to vertical) of the small cell antenna 110 within the radio 200 in order to effectuate an immediate resteering of the antenna main lobe in the elevation plane to thereby maintain a desired terrestrial illumination pattern on the ground. In this manner, the default elevation beamsteering operations will typically control the main lobe direction to point either directly horizontally or at a slight down tilt angle relative to a front face of the small cell radio 200 during low-wind or no-wind conditions when the built-in accelerometer would detect a near vertical/normal orientation for the radio 200. However, in the event the accelerometer detects any deviation of tilt from normal in response to an environmental disturbance such as wind, for example, then signal processing circuitry within the control circuit 212 will initiate an operation to automatically adjust the elevation beam steering in order to maintain the direction of the main lobe illumination toward a desired user location.

As shown by FIG. 2A, the azimuth and elevation beamsteering can be accomplished by applying phase weights, which are stored in memory 214 (e.g., table-based non-volatile memory), to RF phase shifters associated with corresponding elements of an antenna array 110, which are transmitting (or receiving) RF signals. As will be understood by those skilled in the art, by applying these phase weights to adjust the phases of the signals provided to the individual radiating elements in the array 110, the elevation angle of the main lobe can be carefully controlled. Thus, if the accelerometer-based control circuit 212 were to detect a radio tilt deviation of +⊖ in the vertical plane, the signal processing and control functions performed by the control circuit 212 and memory 214 would compensate for this detected tilt by generating and providing an updated set of phase weights to the RF phase shifters in order to preferably steer the main lobe to the −⊖ angle relative to the face of the antenna array 110. The advantages of this generation of updated phase weights in real-time to achieve an elevation beamsteering that compensates for radio tilt is shown schematically by FIGS. 2B-2C, where a right-to-left wind that causes a −⊖ tilt of a strand-mounted radio 200 will be compensated by a +⊖ elevation beam tilt (see, e.g., FIG. 2B) to maintain consistent illumination of a desired terrestrial area, whereas a left-to-right wind that causes a +⊖ tilt of the strand-mounted radio 200 will be compensated by a −⊖ elevation beam tilt (see, e.g., FIG. 2C).

Referring again to FIG. 2A, the strand-mounted small cell base station radio 200 implements azimuth beamsteering using a radio scheduler in a baseband unit 112 to implement spatial multiplexing to multiple users (or clusters of users), in combination with elevation beamsteering, which is controlled by reading an output of an accelerometer in order to compensate for elevation tilt resulting from strand/radio unit sway. This combination of azimuth and elevation beamsteering, which are controlled independently by the scheduler function and the accelerometer-based control function of the radio 200, can be utilized to ensure consistent coverage over a desired small cell sector and provide spatial multiplexing for efficient spectral use. Thus, with respect to the two-dimensional antenna array 110, the RF carrier signals provided to each radiating element (or small group of elements) are controlled in electrical phase by the RF phase shifters in order to implement the dual azimuth and elevation beamsteering. This enables the control of the pointing angle of the main lobe of the array 110 in two dimensions. One dimension is horizontal, or azimuth, beam steering, and the other dimension is vertical, or elevation, beamsteering. As will be understood by those skilled in the art, transmitted signals Tx are encoded and modulated by the MAC and PHY blocks of the baseband unit 112 of the radio 200. The RF channels within the remote radio unit 210 upconvert the transmitted signals to the RF frequency and amplify the signals to their appropriate levels before the RF signal power is then split into multiple paths, with each path being routed through a corresponding phase shifter and then to an antenna array element or group of elements within the antenna array 110. The scheduler block within the baseband unit 112 determines the azimuth angle of each user and, during the time slot used to communicate to a specific user, sends an azimuth beam index (ABI) as a pointer (e.g., address) to be decoded by the phase weighting block 214.

In addition, the accelerometer-based control circuit 212 operates to detect the vertical tilt of the small cell radio 200 relative to a gravity vector and may then internally process a digitized reading of the tilt angle using, for example, an internal compensation look-up table (LUT) (not shown). For each discrete accelerometer-based tilt reading or, more typically, a range of high resolution tilt readings, the control circuit 212 may generate an elevation beam index (EBI), which can correspond to the inverse angle of the accelerometer-based tilt reading(s). For example, if the sensor (e.g., accelerometer) within the control circuit 212 provides a 0.1° tilt resolution, then a range of 10 consecutive tilt readings over a 1° tilt, or possibly 50 tilt readings over a 5° tilt, may be mapped to a single EBI value.

The elevation beam index (EBI) and the azimuth beam index (ABI) may then be processed as respective pointers (e.g., addresses) by the phase weighting block 214. In some embodiments, the EBI may operate as a table identifier to one of a plurality of stored nonvolatile memory tables (corresponding to all of the possible accelerometer-based tilt readings) and the ABI operating as a pointer into a respective table identified by the EBI. The phase weighting block 214 then decodes and translates these EBI and ABI values into electrical phase weights needed to steer the main beam of the antenna 110 to the desired elevation and azimuth directions.

Accordingly, based on these embodiments of the invention, a small cell wireless communication device, such as a strand-mounted small cell base station antenna 200, can include an antenna 110 having an array of radiating elements therein, and a transceiver (e.g., radio) electrically coupled to the antenna by an array of RF phase shifters within a remote radio unit 210. This array of phase shifters can be responsive to control signals that encode phase weight information and enable the array of phase shifters and the array of radiating elements to collectively perform elevation beamsteering of wireless signals generated by the transceiver. In some embodiments, a phase weight generator may be provided, which is configured to generate the control signals in response to an elevation beam index. An accelerometer-based control circuit 212 may also be provided, which is configured to generate and adjust the elevation beam index in response to rotational movement of the antenna 110 about an axis. In additional embodiments, the control signals provided to the array of phase shifters may encode phase weight information that enables the array of phase shifters and the array of radiating elements to collectively perform elevation and azimuth beamsteering of the wireless signals generated by the transceiver. The phase weight generator may also be configured to generate the control signals in response to an azimuth beam index and an elevation beam index. This phase weight generator can include non-volatile memory, which is arranged as a plurality of phase weight look-up tables. And, each value of the elevation beam index may operate as a pointer to a respective one of the plurality of phase weight look-up tables, and each value of the azimuth beam index may operate as a pointer into a corresponding memory location within the plurality of phase weight look-up tables.

The techniques and operations described herein may apply to any of the common wireless standards whether beamsteering is defined as part of the standard or not. For example, the tilt compensation beamsteering can be used without azimuth spatial multiplexing for wireless standards that do not utilize azimuth beamsteering control. Yet, for wireless standard that do utilize azimuth beamsteering, such as 5G NR, 802.11ac, 802.11ad, and others, the tilt compensation beamsteering can be combined with the azimuth spatial multiplexing.

In the drawings and specification, there have been disclosed typical preferred embodiments of the invention and, although specific terms are employed, they are used in a generic and descriptive sense only and not for purposes of limitation, the scope of the invention being set forth in the following claims.

1. A small cell wireless communication device, comprising:
an antenna having an array of radiating elements therein; and
a transceiver electrically coupled to said antenna by an array of phase shifters, which are responsive to control signals that encode phase weight information and enable the array of phase shifters and the array of radiating elements to collectively perform elevation beamsteering of wireless signals generated by said transceiver.

2. The device of claim 1, further comprising:
a phase weight generator configured to generate the control signals in response to an elevation beam index; and
a control circuit configured to generate and adjust the elevation beam index in response to rotational movement of said antenna about an axis.

3. The device of claim 1, wherein the control signals encode phase weight information that enables the array of phase shifters and the array of radiating elements to collectively perform elevation and azimuth beamsteering of the wireless signals generated by said transceiver.

4. The device of claim 3, further comprising a phase weight generator configured to generate the control signals in response to an azimuth beam index and an elevation beam index.

5. The device of claim 4, further comprising a control circuit configured to generate and adjust the elevation beam index in response to rotational movement of said antenna about an axis.

6. The device of claim 5, wherein said phase weight generator comprises non-volatile memory having at least one phase weight look-up table therein.

7. The device of claim 5, wherein said phase weight generator comprises non-volatile memory arranged as a plurality of phase weight look-up tables; wherein each value of the elevation beam index operates as a pointer to a respective one of the plurality of phase weight look-up tables; and wherein each value of the azimuth beam index operates as a pointer into a corresponding memory location within the plurality of phase weight look-up tables.

8. A small cell wireless communication device, comprising:
an antenna having an array of radiating elements therein;
a control circuit; and
a transceiver electrically coupled to said antenna by an array of phase shifters, which are responsive to control signals that encode phase weight information and enable the array of phase shifters and the array of radiating elements to collectively perform elevation beamsteering of wireless signals generated by said transceiver, in response to signals generated by said control circuit in response to movement of said antenna.

9. The device of claim 8, further comprising a phase weight generator configured to generate the control signals in response to an elevation beam index generated by said control circuit.

10. The device of claim 8, further comprising a phase weight generator configured to generate the control signals in response to an elevation beam index, which is generated by said control circuit, and an azimuth beam index.

11. The device of claim 10, wherein said phase weight generator comprises volatile and/or nonvolatile memory arranged as a plurality of phase weight look-up tables; wherein each value of the elevation beam index operates as a pointer to a respective one of the plurality of phase weight look-up tables; and wherein each value of the azimuth beam index operates as a pointer into a corresponding memory location within the plurality of phase weight look-up tables.

12. A wireless communication device, comprising:
an antenna having a two-dimensional array of radiating elements therein;
a multi-channel transceiver electrically coupled to said antenna by an array of phase shifters, which are responsive to control signals comprising a plurality of electrical phase weights; and
a phase weight generator configured to support azimuth and elevation beamsteering by generating the plurality of electrical phase weights in response to an azimuth beam index and an elevation beam index.

13. The device of claim 12, wherein the azimuth beam index encodes azimuth spatial multiplexing information and the elevation beam index encodes an elevation disposition of said antenna.

14. The device of claim 13, further comprising a control circuit configured to adjust the elevation beam index in response to rotational movement of said antenna.

15. The device of claim 13, wherein said phase weight generator comprises a non-volatile memory having a plurality of look-up tables therein.

16. The device of claim 15, wherein the elevation beam index operates as a pointer to select a corresponding one of the plurality of look-up tables and the azimuth beam index operates as a pointer into a selected look-up table identified by the elevation beam index, or vice versa.

17. The device of claim 15, wherein the elevation beam index operates as a pointer to select a corresponding one of the plurality of look-up tables; and wherein the azimuth beam index operates as a pointer into a selected look-up table identified by the elevation beam index, which stores the plurality of electrical phase weights.

18. A wireless communication device, comprising:
a strand-mounted small cell base station radio configured to support azimuth and elevation beamsteering by adjusting phase weights provided to an array of phase shifters coupled to a small cell antenna having an array of radiating elements therein, in response to signals generated by a scheduler that supports spatial multiplexing and a control circuit that monitors a vertical disposition of the small cell antenna.

19. The device of claim 18, wherein the control circuit comprises an accelerometer mounted to the small cell antenna.

20. The device of claim 18, further comprising a look-up table responsive to an azimuth beam index generated by the scheduler and an elevation beam index generated by the control circuit.

21.-22. (canceled)
